(19) United States
(12) Patent Application Publication
(10) Pub. No.: US 2019/0220170 A1
(43) Pub. Date: Jul. 18, 2019

(54) METHOD AND APPARATUS FOR CREATING GROUP

(71) Applicant: HUAWEI TECHNOLOGIES CO., LTD., Shenzhen (CN)

(72) Inventors: Jinglong ZHANG, Hangzhou (CN); Shichun WANG, Hangzhou (CN)

(21) Appl. No.: 16/287,908

(22) Filed: Feb. 27, 2019

Related U.S. Application Data
(63) Continuation of application No. PCT/CN2017/077929, filed on Mar. 23, 2017.

(30) Foreign Application Priority Data
Aug. 30, 2016 (CN) 201610767373.0

(51) Int. Cl. G06F 3/0484; G06F 3/0482; G06F 3/0481

(52) U.S. Cl. CPC G06F 3/04842; G06F 3/04845; G06F 3/04817; G06F 3/0482

(57) ABSTRACT

A method for creating a group is disclosed, the method includes: presenting, by a terminal, at least one object on a display user interface; and when the terminal detects a first operation for a first object, reserving at least one to-be-selected object on the display user interface according to a preset group attribute of the first object, and triggering the at least one to-be-selected object to enter a to-be-grouped editing state. The method further incudes when the terminal detects a curved slide operation, and a track of the curved slide operation passes through multiple to-be-selected objects an odd number of times, using the multiple to-be-selected objects as one group, where the track of the curved slide operation is a non-closed curve. Therefore, a group can be quickly created, operations can be reduced, and operation efficiency can be improved.

### CROSS-REFERENCE TO RELATED APPLICATIONS

This application is a continuation of International Application No. PCT/CN2017/077929, filed on Mar. 23, 2017, which claims priority to Chinese Patent Application No. 201610767373.0, filed on Aug. 30, 2016; which applications are herein incorporated by reference in their entireties.

### TECHNICAL FIELD

Embodiments of the present invention relate to the terminal field, and in particular, to a method and an apparatus for creating a group.

### BACKGROUND

As a terminal has increasing functions, a processing capability of the terminal is gradually enhanced. Therefore, a scenario often appears in which the terminal needs to process a large amount of information of a same type. However, in the prior art, the terminal has relatively low efficiency in processing information of a same type. A user usually needs to manually perform operations one by one. Consequently, a relatively large quantity of operations are needed, operation efficiency is relatively low, user experience is relatively poor, and a misoperation may be easily caused by the user.

The following uses two specific scenarios as an example to describe the foregoing problem.

A scenario 1 is a scenario of creating an application group.

After downloading multiple applications, the user often needs to group the downloaded multiple applications. In this case, the user needs to drag the applications one by one into a corresponding group, that is, a folder. Therefore, when many applications need to be grouped, a relatively large quantity of operations need to be performed by the user, and operation efficiency is relatively low. Particularly, when the user needs to perform a multi-screen operation on the application, a misoperation may be easily caused.

A scenario 2 is a scenario of creating a contact group:

It is assumed that a user needs to send a group message to some contacts or establish a temporary group. These contacts are used as one group. The following two processes may be performed by different terminals to create the group:
Process 1: Open a creation portal->Select contacts->Complete;
Process 2: Open a creation portal->Edit a group name->Select contacts->Complete.

In the process 1 and the process 2, the user needs to tap all contacts one by one. When there are an excessively large quantity of contacts, the user further needs to search for names of contacts to complete the operation. Therefore, a relatively large quantity of operations need to be performed by the user, operation efficiency is relatively low, and excessive time is needed.

### SUMMARY

An objective of the present invention is to provide a method and an apparatus for creating a group, so as to resolve a problem that when a user needs to process a large amount of information of a same type, a relatively large quantity of operations need to be performed, and operation efficiency is relatively low.

The objective of the present invention is achieved by using the following technical solutions:

According to a first aspect, a method for creating a group is provided, including: presenting, by a terminal, at least one object on a display user interface; when the terminal detects a first operation for a first object, reserving at least one to-be-selected object on the display user interface according to a preset group attribute of the first object, and triggering the at least one to-be-selected object to enter a to-be-grouped editing state, where the first object is any object in the at least one object, the first operation is used to trigger the first object to enter the to-be-grouped editing state, the to-be-selected object and the first object have any same preset group attribute, and the at least one to-be-selected object includes the first object; and when the terminal detects a curved slide operation, and a track of the curved slide operation passes through multiple to-be-selected objects an odd number of times, using the multiple to-be-selected objects as one group, where the track of the curved slide operation is a non-closed curve. By means of the foregoing method, the terminal can recommend the at least one to-be-selected object to the user according to the detected first operation for the first object and the preset group attribute of the first object; and when detecting the curved slide operation of the user, the terminal uses the multiple to-be-selected objects through which the track of the curved slide operation passes an odd number of times as one group. Therefore, the terminal can quickly and centrally process the multiple to-be-selected objects, the operation is convenient, and the operation efficiency is improved.

In one embodiment, the reserving, by the terminal, at least one to-be-selected object on the display user interface according to a preset group attribute of the first object includes: when the first object has only one preset group attribute, using, by the terminal, an object that has the only one preset group attribute as the to-be-selected object, and reserving the object on the display user interface. Therefore, the terminal can effectively recommend the to-be-selected object to the user according to the preset group attribute of the first object.

In one embodiment, the reserving, by the terminal, at least one to-be-selected object on the display user interface according to a preset group attribute of the first object includes: when the first object has at least two preset group attributes, presenting, by the terminal, the at least two preset group attributes on the display user interface; and when the terminal detects a second operation for at least one preset group attribute in the at least two preset group attributes, using an object that has the at least one preset group attribute as the to-be-selected object, and reserving the object on the display user interface, where the second operation is used to enable the terminal to determine an object that needs to be reserved on the display user interface. Therefore, the terminal can recommend a specific to-be-selected object to the user according to the second operation of the user.

In addition, when the first object has the at least two preset group attributes, the terminal presents an object that has the at least two preset group attributes of the first object on the display user interface.

When the terminal reserves the at least one to-be-selected object on the display user interface, all to-be-selected objects may be regularly distributed; or may be irregularly distributed, for example, may be distributed in a scattered manner.

In one embodiment, the presenting, by a terminal, at least one object on a display user interface includes: presenting, by the terminal, at least one preset group attribute of the first object on the display user interface; and in this case, the first operation is: determining a target preset group attribute, and triggering the first object to enter the to-be-grouped editing state, where the target group attribute is one of the at least one preset group attribute, and further, when the terminal reserves the at least one to-be-selected object on the display user interface according to the preset group attribute of the first object, reserving all objects that have the target group attribute on the display user interface. Therefore, the terminal can recommend the specific to-be-selected object to the user.

In one embodiment, the track of the curved slide operation is a curve starting with the first object. In addition, the track of the curved slide operation may start with any to-be-selected object. Therefore, the curved slide operation according to this embodiment of the present invention is more flexible and convenient.

In one embodiment, the method further includes: when the terminal detects that the track of the curved slide operation is a closed curve starting and ending with the any to-be-selected object, ending a process of creating a group. The curved slide operation according to this embodiment of the present invention is more flexible and convenient.

In one embodiment, the method further includes: when the terminal detects that the track of the curved slide operation reaches a second object an odd number of times, changing a background color of an induction area of the second object from a first color to a second color, where the second object is any one of the at least one to-be-selected object, the second color and the first color are different, the first color is used to indicate that the second object is not selected, and the second color is used to indicate that the second object is selected. In addition to using a background color of an induction area of a to-be-selected object as a criterion for distinguishing between a selected object and an unselected object, one subscript may be added for the selected object, or the terminal displays a name or a thumbnail of the selected object in a preset area of the display user interface. Therefore, in the method according to this embodiment of the present invention, selected objects and unselected objects can be clearly displayed to the user, thereby improving user experience.

In one embodiment, the method further includes: after the using, by the terminal, the multiple to-be-selected objects as one group, the method further includes: presenting, by the terminal, at least two editing options on the display user interface, where the editing option is used by a user to perform a uniform operation on an object in the group; and when the terminal detects a triggering operation for any editing option, performing an operation corresponding to the any editing option on the object in the group. Therefore, the method according to this embodiment of the present invention enables the user to conveniently perform a subsequent on a created group.

In one embodiment, when the terminal cannot completely present all to-be-selected objects on the current display user interface, displaying the to-be-selected objects in a multi-screen manner is also supported. For example, after a user's finger slides to an edge of a screen and stays for a preset period, the current screen automatically switches to a new screen, and the user may continue to operate.

According to a second aspect, a method for creating a group is provided, including: presenting, by a terminal, at least one object on a display user interface; when the terminal detects a first operation for a first object, reserving at least one to-be-selected object on the display user interface according to a preset group attribute of the first object, and triggering the at least one to-be-selected object to enter a to-be-grouped editing state, where the first object is any object in the at least one object, the first operation is used to trigger the first object to enter the to-be-grouped editing state, and the to-be-selected object and the first object have any same preset group attribute; and when the terminal detects that a track of a curved slide operation reaches a second object a second time, determining to deselect the second object from the group, where the second object is any one of the at least one to-be-selected object. Therefore, an embodiment of the present invention provides a method for deselecting a selected to-be-selected object, so that a user can flexibly and conveniently select or deselect the to-be-selected object, and operation efficiency is improved.

In one embodiment, that the terminal detects that the track of the curved slide operation reaches the second object the second time, includes: changing, by the terminal, a background color of an induction area of the second object from a first color to a second color, where the second color and the first color are different, the first color is used to indicate that the second object is not selected, and the second color is used to indicate that the second object is selected. Therefore, in the method according to this embodiment of the present invention, selected objects and unselected objects can be clearly displayed to the user, thereby improving user experience.

According to a third aspect, an embodiment of the present invention further provides an apparatus for creating a group, including: a display unit and a processing unit. The display unit is configured to present at least one object on a display user interface. The processing unit is configured to: when a first operation for a first object is detected, reserve at least one to-be-selected object on the display user interface according to a preset group attribute of the first object, and trigger the at least one to-be-selected object to enter a to-be-grouped editing state, where the first object is any object in the at least one object, the first operation is used to trigger the first object to enter the to-be-grouped editing state, and the to-be-selected object and the first object have any same preset group attribute; and when a curved slide operation is detected, and a track of the curved slide operation passes through multiple to-be-selected objects an odd number of times, use the multiple to-be-selected objects as one group, where the track of the curved slide operation is a non-closed curve.

According to a fourth aspect, an embodiment of the present invention further provides a terminal device. The terminal device includes a display device, a memory, and a processor, where the memory is configured to store a computer program, and the processor is configured to read the computer program stored in the memory and implement the method according to any one of the first aspect or the implementations of the first aspect.

### BRIEF DESCRIPTION OF DRAWINGS

FIG. 1 is a schematic structural diagram of a terminal device applied to an embodiment of the present invention;

FIG. 2 is an overall flowchart of creating a group according to an embodiment of the present invention;

FIG. 3 is a schematic diagram of determining, by a terminal, at least one preset group attribute according to an embodiment of the present invention;

FIG. 4(a) is a first specific schematic diagram of creating a contact group according to an embodiment of the present invention;

FIG. 4(b) is a second specific schematic diagram of creating a contact group according to an embodiment of the present invention;

FIG. 5(a) is a first specific schematic diagram of creating an object group according to an embodiment of the present invention;

FIG. 5(b) is a second specific schematic diagram of creating an object group according to an embodiment of the present invention;

FIG. 5(c) is a third specific schematic diagram of creating an object group according to an embodiment of the present invention;

FIG. 5(d) is a fourth specific schematic diagram of creating an object group according to an embodiment of the present invention;

FIG. 5(e) is a fifth specific schematic diagram of creating an object group according to an embodiment of the present invention;

FIG. 5(f) is a sixth specific schematic diagram of creating an object group according to an embodiment of the present invention;

FIG. 5(g) is a seventh specific schematic diagram of creating an object group according to an embodiment of the present invention;

FIG. 5(h) is an eighth specific schematic diagram of creating an object group according to an embodiment of the present invention;

FIG. 6(a) is a first specific schematic diagram of creating a desktop folder according to an embodiment of the present invention;

FIG. 6(b) is a second specific schematic diagram of creating a desktop folder according to an embodiment of the present invention;

FIG. 6(c) is a third specific schematic diagram of creating a desktop folder according to an embodiment of the present invention;

FIG. 6(d) is a fourth specific schematic diagram of creating a desktop folder according to an embodiment of the present invention;

FIG. 6(e) is a fifth specific schematic diagram of creating a desktop folder according to an embodiment of the present invention;

FIG. 7(a) is a first specific schematic diagram of creating a group messaging group according to an embodiment of the present invention;

FIG. 7(b) is a second specific schematic diagram of creating a group messaging group according to an embodiment of the present invention;

FIG. 7(c) is a third specific schematic diagram of creating a group messaging group according to an embodiment of the present invention;

FIG. 7(d) is a fourth specific schematic diagram of creating a group messaging group according to an embodiment of the present invention;

FIG. 7(e) is a fifth specific schematic diagram of creating a group messaging group according to an embodiment of the present invention; and

FIG. 8 is a schematic structural diagram of an apparatus for creating a group according to an embodiment of the present invention.

### DESCRIPTION OF EMBODIMENTS

The following clearly describes the technical solutions in the embodiments of the present invention with reference to the accompanying drawings in the embodiments of the present invention.

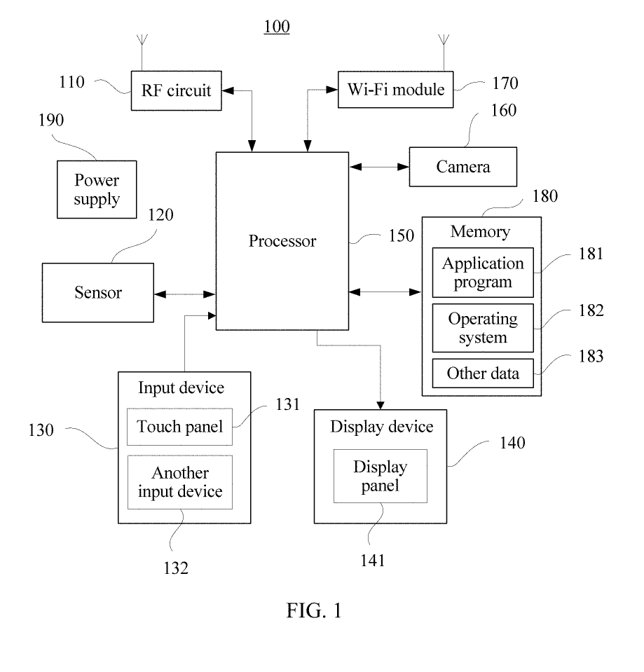

A method for creating a group according to an embodiment of the present invention is mainly applied to a terminal device. The terminal device may also be referred to as user equipment (UE), a mobile station (MS), a mobile terminal, or the like. In one embodiment, the terminal can communicate with one or more core networks by using a radio access network (Radio Access Network, RAN). For example, the terminal may be a mobile phone (also referred to as a “cellular” phone), or a computer with a mobility feature. Alternatively, the terminal may be a portable, pocket-sized, handheld, computer built-in, or in-vehicle mobile apparatus. Referring to FIG. 1, FIG. 1 is a schematic structural diagram of a terminal device applied to an embodiment of the present invention. A terminal device 100 includes a memory 180, a processor 150, and a display device 140. The memory 180 stores a computer program, and the computer program includes an operating system 182, an application program 181, or the like. The processor 150 is configured to read the computer program in the memory 180, and then executes a method defined by the computer program. For example, the processor 150 reads the operating system 182, so as to run the operating system and implement various functions of the operating system on the terminal device 100, or reads one or more application programs 181, so as to run the application or applications on the terminal device.

In addition, the memory 180 further stores other data 183 other than the computer program, and the other data 183 may include data generated after the operating system 182 or the application program 181 runs.

The memory 180 usually includes an internal memory and an external memory. The internal memory may be a random access memory (RAM), a read-only memory (ROM), a cache, or the like. The external memory may be a hard disk, an optical disc, a USB flash drive, a floppy disk, a tape drive, or the like.

The operating system 182 includes a computer program that can implement the method for creating a group according to this embodiment of the present invention, so that after the processor 150 reads the operating system 182 and runs the operating system, the operating system may have a function of creating a group according to this embodiment of the present invention. Further, the operating system can open a call interface of the function of creating a group to an upper-layer application. After the processor 150 reads the application program 181 in the memory 180 and runs the application, for example, WeChat, the application can call the function of creating a group provided in the operating system by using the call interface, so as to create a group for WeChat contacts.

The terminal device 100 may further include an input device 130, configured to: receive digital information or character information that is input, a contact touch operation/non-contact gesture; and generate signal input that is related to a user setting and a function control of the terminal device 100. In this embodiment of the present invention, the input device 130 may include a touch panel 131. The touch panel 131, which is also referred to as a touchscreen, can collect a touch operation of a user that is performed on or nearby the touch panel 131, and drive a corresponding connection apparatus according to a preset program. In one embodiment, the touch panel 131 may include two parts: a touch detection apparatus and a touch controller. The touch detection apparatus detects a touch position of the user, detects a signal generated by a touch operation, and transfers the signal to the touch controller. The touch controller receives touch information from the touch detection apparatus, converts the touch information into coordinates of a touch point, and then sends the coordinates of the touch point to the processor 150. In addition, the touch controller can receive and execute a command sent by the processor 150. For example, if the user taps an application icon on the touch panel 131 with a finger, the touch detection apparatus detects a signal generated by the tap, and transfers the signal to the touch controller. Then, the touch controller converts the signal into coordinates, and sends the coordinates to the processor 150; and then the processor 150 performs an operation on the application according to the coordinates and a signal type (that is, the tap), and finally displays an open interface of the application on a display panel 141, so as to open the application.

The touch panel 131 may be implemented in multiple types, such as a resistive type, a capacitive type, infrared, and a surface acoustic wave. In addition to the touch panel 131, the input device 130 may further include another input device 132. The another input device 132 may include but is not limited to one or more of a physical keyboard, a function key (such as a volume control key or an on/off key), a trackball, a mouse, a joystick, or the like.

The terminal device 100 may further include the display device 140. The display device 140 includes the display panel 141, configured to display information that is input by the user, information provided for the user, and various menu interfaces of the terminal device 100. In this embodiment of the present invention, the display device 140 may be configured to display each to-be-selected object that is needed for creating a group, for example, an application icon or a contact profile picture. The display device 140 may include the display panel 141, and in one embodiment, the display panel 141 may be configured in a form of an LCD (Liquid Crystal Display, liquid crystal display), an OLED (Organic Light-Emitting Diode, organic light-emitting diode), or the like. In some other embodiments, the touch panel 131 may cover the display panel 141, so as to form a touch display screen.

In addition, the terminal device 100 may further include: a power supply 190 configured to supply power to another module, and a camera 160 configured to shoot a photograph or a video. The terminal device 100 may further include one or more sensors 120, for example, an acceleration sensor, an optical sensor, or a pressure sensor. The terminal device 100 may further include a radio frequency (Radio Frequency, RF) circuit 110 configured to perform network communication with a wireless network device, and may further include a Wi-Fi module 170 configured to perform Wi-Fi communication with another device.

In this embodiment of the present invention, it is implemented that a group is quickly created based on to-be-selected objects, thereby reducing operations of the user and improving operation efficiency. The following embodiment describes in detail a function of creating a group provided at an operating system layer of the terminal. Further, optionally, the operating system layer may provide the function of creating a group for an application layer, so as to improve user experience provided by an application at the application layer.

It should be understood that the object mentioned in this embodiment of the present invention may be an application icon, contact information, a photo, a book, a video, a bookmark, an unread message, a spam message, or the like.

It should be understood that a preset group attribute is a basis for the terminal to determine the to-be-selected object. In one embodiment, when the object is a person, for example, contacts in a contact list or WeChat or a person followed in microblog, a preset group attribute for a person may be various social relationships, for example, colleagues, family members, or classmates, and may further be various occupations, for example, teachers, civil servants, or lawyers. When the object is something, for example, a picture, a video, a book, music, or a message, a preset group attribute for a picture and a video may be a shooting place, a shooting time, a shooting type (including a panorama, a surround picture, and the like), a shooting style, a format, or the like. A preset group attribute for a book may be an author, a book type (including novel, prose, poetry, and the like), a language, or the like. A preset group attribute for music may be a music style (including rock and roll, country, pop, and the like), a singer, a mood, an instrument, an era, a region, or the like. A preset group attribute for a message may be a reading status (including read and unread), a recipient, a sender, or the like. The message herein may be a short message, a notification, an email, or the like.

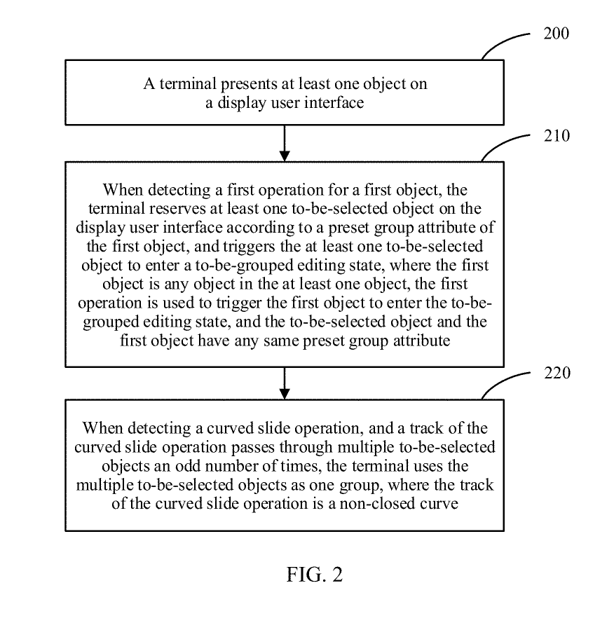

Referring to FIG. 2, FIG. 2 is a method for creating a group according to an embodiment of the present invention. The method includes the following operations:

In operation 200, a terminal presents at least one object on a display user interface.

In operation 210, when detecting a first operation for a first object, the terminal reserves at least one to-be-selected object on the display user interface according to a preset group attribute of the first object, and triggers the at least one to-be-selected object to enter a to-be-grouped editing state, where the first object is any object in the at least one object, the first operation is used to trigger the first object to enter the to-be-grouped editing state, and the to-be-selected object and the first object have any same preset group attribute.

In operation 220, when detecting a curved slide operation, and a track of the curved slide operation passes through multiple to-be-selected objects an odd number of times, the terminal uses the multiple to-be-selected objects as one group, where the track of the curved slide operation is a non-closed curve.

In operation 210, the first operation is a preset operation such as a touch and hold, a force touch, or the like that is different from a common selection.

It should be understood that the at least one to-be-selected object includes the first object.

In one embodiment, when reserving the at least one to-be-selected object on the display user interface, the terminal hides another object other than the at least one to-be-selected object, and hiding manners used herein may include but are not limited to the following:
(1) The terminal performs blur processing on the another object other than the at least one to-be-selected object;
(2) The terminal increases transparency of the another object other than the at least one to-be-selected object;
(3) The terminal performs mask processing on the another object other than the at least one to-be-selected object.

In one embodiment, when the terminal reserves the at least one to-be-selected object on the display user interface according to the preset group attribute of the first object, according to different quantities of preset group attributes of the first object, the manners that can be used include but are not limited to the following:

Manner 1: When the first object has only one preset group attribute, the terminal uses an object that has the only one preset group attribute as the to-be-selected object, and reserves the object on the display user interface.

For example, after the terminal detects a first operation for an application icon of TAOBAO®, the terminal analyzes a preset group attribute of the application icon TAOBAO®. It is assumed that the application icon TAOBAO° has only one preset group attribute: “shopping”. In this case, the terminal searches all installed applications, and reserves an application icon of an application that has the preset group attribute “shopping” as the to-be-selected object on the display user interface of the terminal; for example, the terminal reserves application icons of five applications on the display user interface: TAOBAO®, JINGDONG®, TMALL®, DANGDANG®, and AMAZON®.

Manner 2: When the first object has at least two preset group attributes, the terminal presents the at least two preset group attributes on the display user interface; and when detecting a second operation for at least one preset group attribute in the at least two preset group attributes, the terminal uses an object that has the at least one preset group attribute as the to-be-selected object, and reserves the object on the display user interface, where the second operation is used to enable the terminal to determine an object that needs to be reserved on the display user interface.

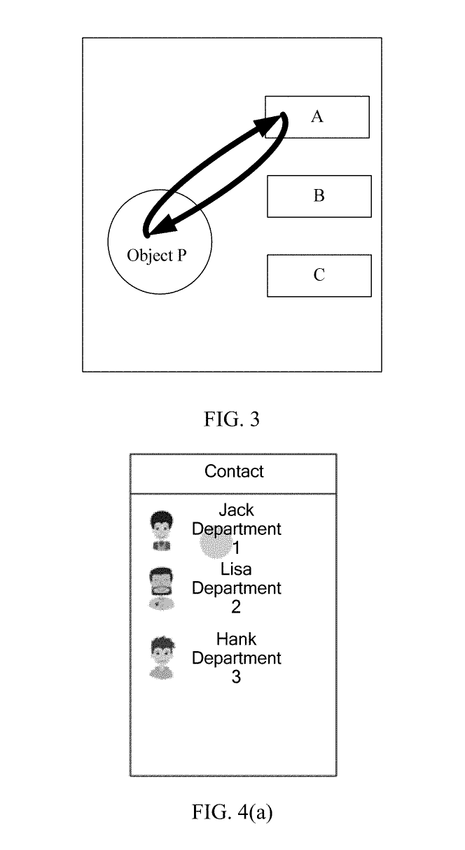

In one embodiment, the second operation may refer to a slide operation that starts and ends with the first object and that passes through the at least one preset group attribute, or a tap operation for the at least one preset group attribute. For example, referring to FIG. 3, an object P has three preset group attributes: A, B, and C. The terminal presents the object P and the three preset group attributes A, B, and C on the display user interface. A user's finger slides from an induction area of the object P to an induction area of A on the display user interface, and then returns to the induction area of the object P to complete a selection of A. After the user's finger leaves the display user interface, the terminal presents an object that has the preset group attribute A on the display user interface. In addition, after the user completes the selection of A, if the user's finger does not leave the display user interface, but slides again from the induction area of the object P to the induction area of A on the display user interface, A is deselected. When the user's finger stays at an empty area for a period longer than a preset period, a process of selecting a preset group attribute ends, and the procedure returns to step 200.

For example, after the terminal detects a first operation for an icon of Stories of the Sahara in a reading application A, the terminal analyzes a preset group attribute of Stories of the Sahara. It is assumed that Stories of the Sahara has two preset group attributes: “San Mao” and “prose”. In this case, the terminal presents the two preset group attributes “San Mao” and “prose” of Stories of the Sahara on the display user interface. When the terminal detects a second operation for San Mao, the terminal searches for an icon of a book that has the preset group attribute “San Mao” in all books as the to-be-selected object, and reserves the object on the display user interface. For example, the terminal reserves icons of three books on the display user interface: Stories of the Sahara, Gone with the Rainy Season, and Scarecrow Notes.

Manner 3: When the first object has at least two preset group attributes, the terminal presents an object that has the at least two preset group attributes of the first object on the display user interface.

For example, after the terminal detects a first operation for an email 1 and determines that an object 1 has two preset group attributes: “unread” and “sent by Mr. Zhang”, in this case, the terminal searches all emails, and reserves any email that has the preset group attributes “unread” and “sent by Mr. Zhang” as the to-be-selected object on the display user interface of the terminal.

In one embodiment, when reserving the at least one to-be-selected object on the display user interface, the terminal triggers the at least one to-be-selected object to enter the to-be-grouped editing state. In this case, the presentation manners that can be used include but are not limited to the following:
(1) Emergence, for example, sequential emergence, simultaneous emergence, or a distribution effect from far to near or from small to big presented by each object;
(2) Scrolling, for example, unidirectional scrolling or multi-directional scrolling;
(3) Jittering;
(4) Flickering;
(5) Jerking.

When the terminal reserves the at least one to-be-selected object on the display user interface, all to-be-selected objects may be regularly distributed; or may be irregularly distributed, for example, may be distributed in a scattered manner.

For step 200 and step 210, in one embodiment, when the terminal presents the at least one object on the display user interface, the terminal presents at least one preset group attribute of the first object on the display user interface; the first operation is: determining a target preset group attribute, and triggering the first object to enter the to-be-grouped editing state, where the target group attribute is one of the at least one preset group attribute; the reserving, by the terminal, at least one to-be-selected object on the display user interface according to a preset group attribute of the first object is: reserving all objects that have the target group attribute on the display user interface.

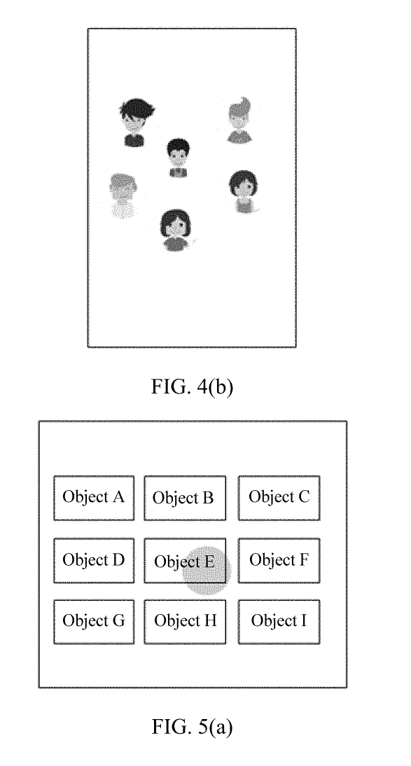

For example, as shown in FIG. 4(a), the terminal presents a preset group attribute of each contact on the display user interface, that is, a department to which each contact belongs; and the terminal detects a first operation for a “department 1”, that is, determines that the target preset group attribute is “department 1”. Further, as shown in FIG. 4(b), the terminal reserves all contact profile pictures that have the preset group attribute “department 1” on the display user interface. As a to-be-selected object, each to-be-selected object is in the to-be-grouped editing state. It should be noted that in FIG. 4(b), the terminal presents a profile picture of each to-be-selected object on the display user interface, and in one embodiment, and may further present two parts of each to-be-selected object: a name and a profile picture, or present three parts of each to-be-selected object: a name, a profile picture, and a “department 1”.

For operation 220, the track of the curved slide operation may be a curve starting with the first object.

It should be understood that the track of the curved slide operation may start with any to-be-selected object.

In one embodiment, when the terminal cannot completely present all to-be-selected objects on the current display user interface, displaying the to-be-selected objects in a multi-screen manner is also supported. For example, after the user's finger slides to an edge of a screen and stays for a preset period, the current screen automatically switches to a new screen, and the user may continue to operate.

The track of the curved slide operation passes through the multiple to-be-selected objects an odd number of times, the multiple to-be-selected objects are used as a same group. The following two cases may be included.

Case 1: When the track of the curved slide operation passes through the multiple to-be-selected objects for the first time, the multiple to-be-selected objects are used as one group.

Case 1 is relatively common, and is an optional implementation of the present invention.

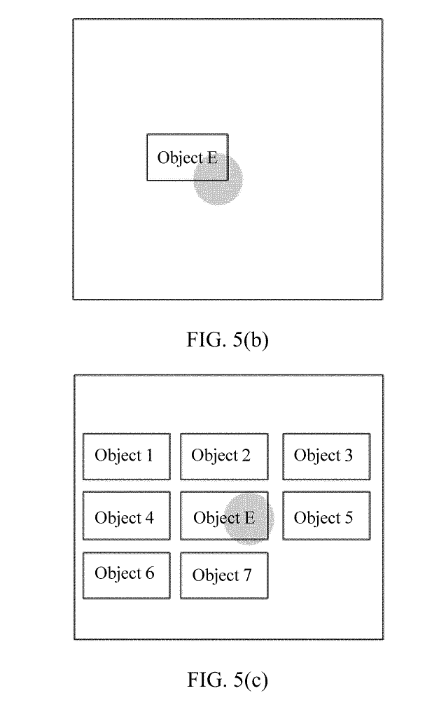

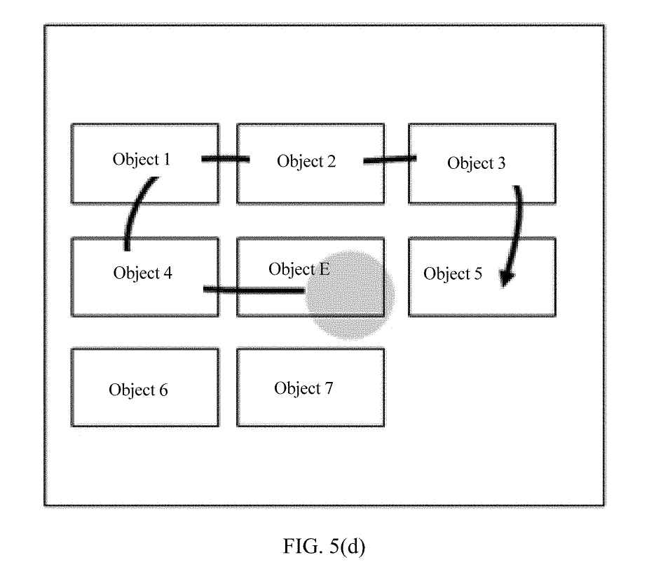

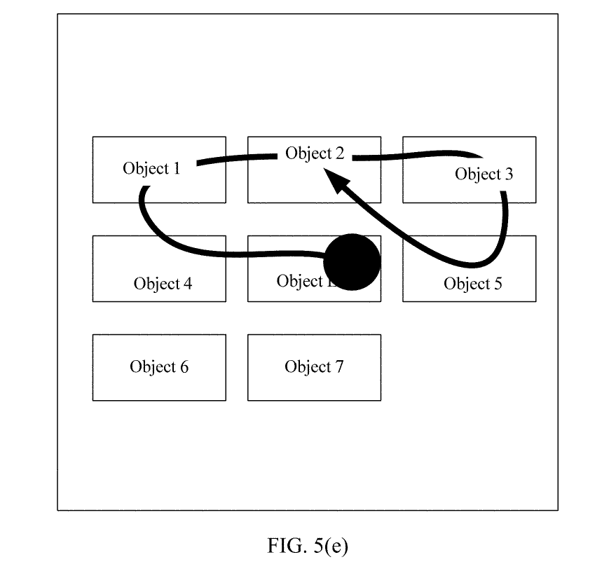

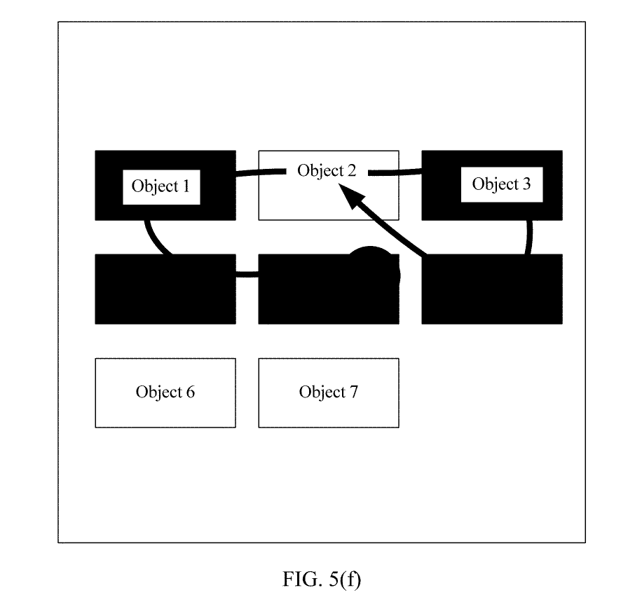

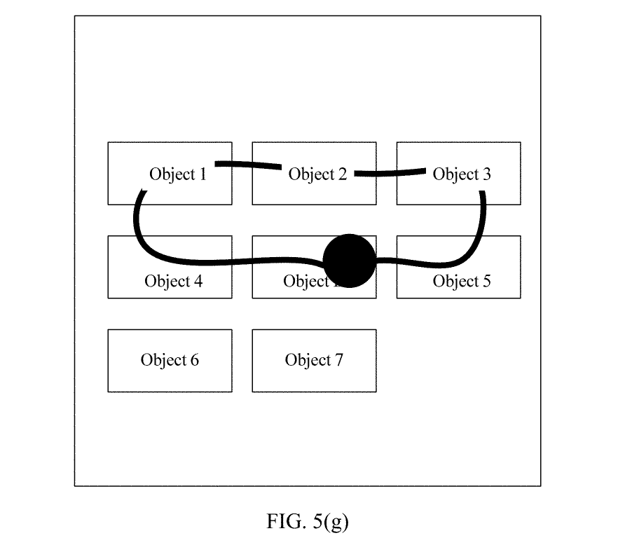

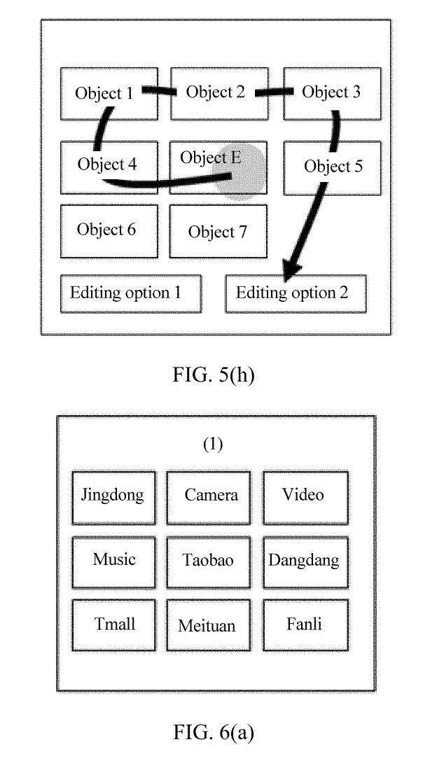

For example, as shown in FIG. 5(a), the terminal presents an object A to an object I on the display user interface; and the terminal detects a first operation for an object E, and hides the object A to the object I other than the object E. As shown in FIG. 5(b), the terminal reserves an object 1 to an object 7 and the object E according to a preset group attribute of the object E. As shown in FIG. 5(c), the object 1 to the object 7 and the object E have any same preset group attribute. The terminal detects the curved slide operation, and the track of the curved slide operation starts with the object E, and passes through an object 1 to an object 5. Therefore, as shown in FIG. 5(d), the object E and the object 1 to the object 5 constitute one group.

Case 2: When the track of the curved slide operation reaches one to-be-selected object an even number of times (that is, 2n times), the to-be-selected object is deselected from a group. If the to-be-selected object needs to be reselected, the track of the curved slide operation needs to pass through the to-be-selected object again. Therefore, the track of the curved slide operation reaches the to-be-selected object 2n+1 times, and it is determined that the object is selected into the group, where n≥1.

For example, as shown in FIG. 5(d), when the terminal determines that the track of the curved slide operation reaches an object 2 for the first time, it is determined that the object 2 is selected. For example, as shown in FIG. 5(e), when the terminal determines that the track of the curved slide operation returns to the object 2 again after leaving the object 2, that is, when the track of the curved slide operation reaches the object 2 an even number of times, it is determined that the object 2 is deselected.

In one embodiment, when detecting that the track of the curved slide operation reaches a second object an odd number of times, the terminal changes a background color of an induction area of the second object from a first color to a second color; or when detecting that the track of the curved slide operation reaches the second object an even number of times, the terminal changes the background color of the induction area of the second object from the second color to the first color. The second object is any one of the at least one to-be-selected object, the second color and the first color are different, the first color is used to indicate that the second object is not selected, and the second color is used to indicate that the second object is selected.

For example, referring to FIG. 5(f), when a to-be-selected object is selected, a background color of an induction area of the object is gray; or when a to-be-selected object is not selected, the background color of the induction area of the object is white.

It should be understood that in addition to using a background color of an induction area of a to-be-selected object as a determination criterion for distinguishing between a selected object and an unselected object, one subscript may be added for the selected object, or the terminal displays a name or a thumbnail of the selected object on a preset area of the display user interface. Details are not described herein again.

In one embodiment, when detecting that the track of the curved slide operation is a closed curve starting and ending with any to-be-selected object, the terminal ends a process of creating a group.

For example, as shown in FIG. 5(g), the terminal detects a curved slide operation for the object 1 to the object 7, and a curve corresponding to the curved slide operation starts with the object E, passes through induction areas respectively corresponding to the object 1 to the object 5, and ends with the object E to constitute a closed curve, it indicates that a user wants to end and exit a current process of creating a group.

In one embodiment, after the terminal uses the multiple to-be-selected objects as one group, the terminal presents at least two editing options on the display user interface, and the editing option is used by a user to perform a uniform operation on an object in the group; when detecting a triggering operation for any editing option, the terminal performs an operation corresponding to the any editing option on the object in the group.

The following describes several possible editing options:
(1) Send a message, or send an email;
(2) Delete, or uninstall;
(3) Mark as a read state;
(4) Search;
(5) Compress;
(6) Share;
(7) Print;
(8) Release;
(9) Encrypt;
(10) Lock;
(11) Hide.

In one embodiment, when there is only one editing option, for example, the editing option is fixed, or the editing option is determined before the first object is selected, the terminal directly performs an operation corresponding to the editing option on the object in the group. For example, the terminal presents an editing interface used for sending a group message to contacts in the group, or performs a printing operation on a file in the group.

When there are more than one editing option, the terminal needs to detect a triggering operation for at least one editing option. The triggering operation for the editing option includes but is not limited to a slide, a tap, or the like.

For example, as shown in FIG. 5(h), the terminal further presents an editing option 1 and an editing option 2 on the display user interface. When the terminal detects a triggering operation for the editing option 2, that is, the track of the curved slide operation further passes through the editing option 2, the terminal performs an operation corresponding to the editing option 2 on the object in the group.

It should be understood that the terminal may display the editing option before the group is successfully created or after the group is successfully created.

The following describes a detailed process of creating a group with reference to specific embodiments.

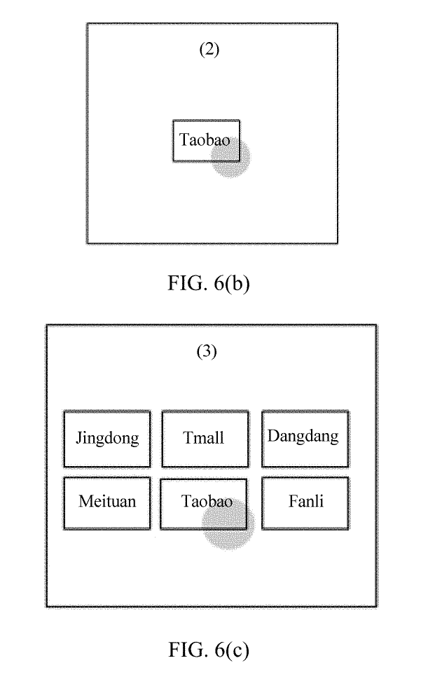

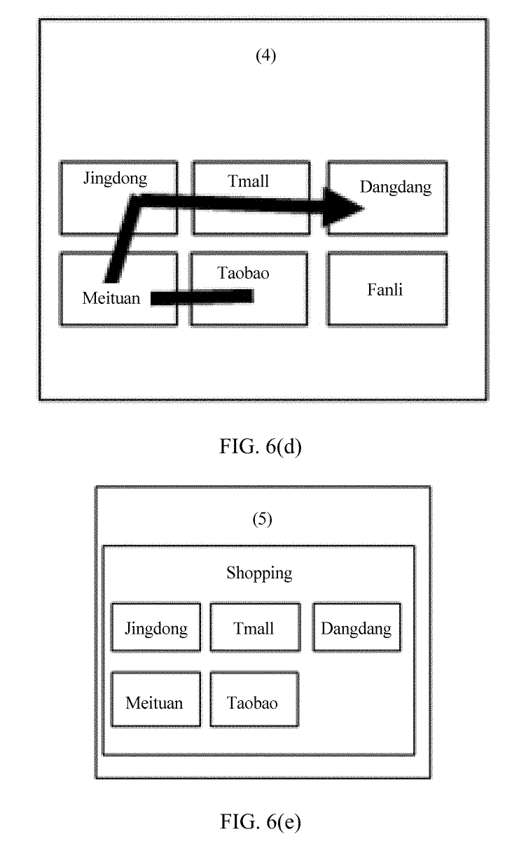

Referring to FIG. 6(a) to FIG. 6(e), it is assumed that a current application scenario is that a user needs to classify downloaded applications and create a desktop folder. A terminal presents nine applications shown in FIG. 6(a) on a display user interface. The terminal detects a first operation for the application icon TAOBAO° and hides other eight applications, as shown in FIG. 6(b). The terminal reserves, according to a preset group attribute of the application icon TAOBAO®, for example, “shopping”, icons of six applications as to-be-selected objects on the display user interface: TAOBAO®, JINGDONG®, TMALL®, DANGDANG®, MEITUAN®, and FANLI®, as shown in FIG. 6(c). It may be learned that a to-be-selected object may be from the other eight icons that are originally displayed on the display user interface, or may be an icon that is not displayed on the current display user interface. The terminal detects a curved slide operation, and a start point of the curved slide operation is the application icon TAOBAO®. If a track of the curved slide operation passes through the application icons TAOBAO®, MEITUAN®, JINGDONG®, TMALL®, and DANGDANG®, the five applications constitute one group. Because an editing option is fixed, that is, creating a desktop folder, the terminal presents a created folder on the display user interface, and automatically names the folder “shopping”. In addition, the terminal may further rename the folder according to detected user input.

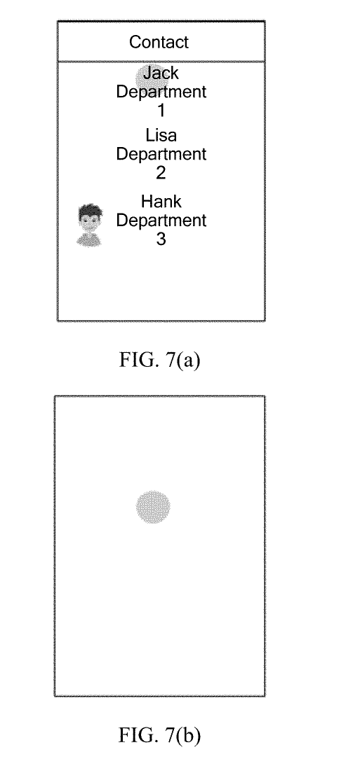

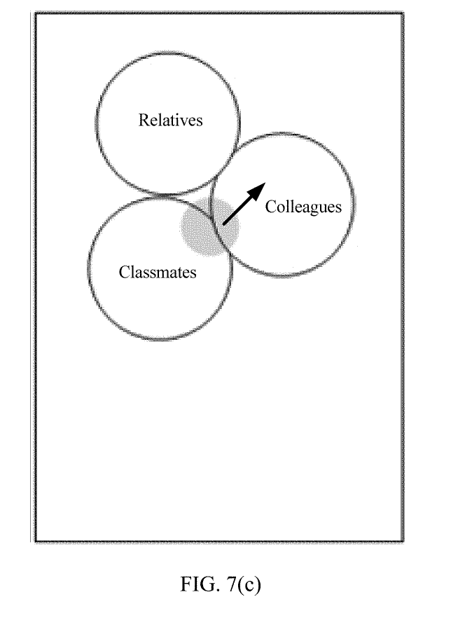

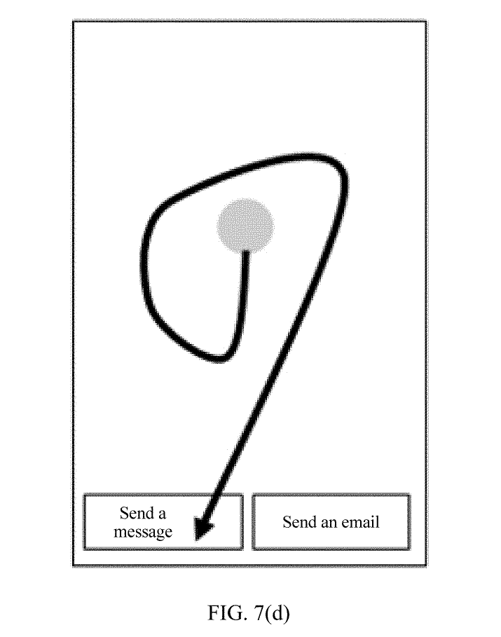

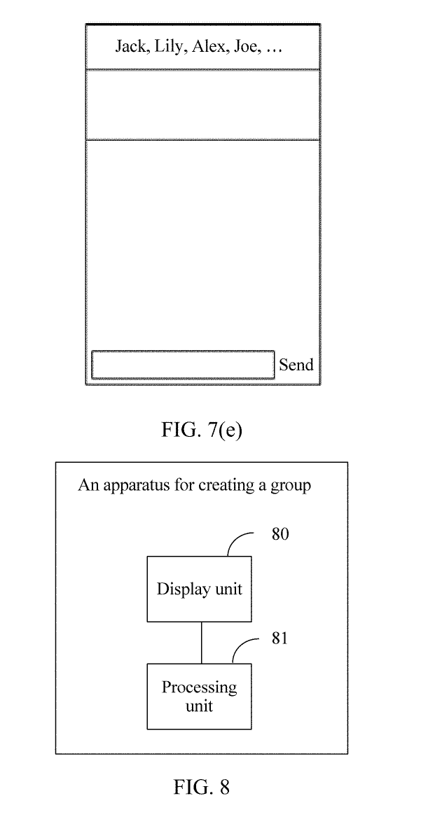

Referring to FIG. 7(a) to FIG. 7(e), it is assumed that a current application scenario is that a user needs to send a group message. A terminal presents three contacts shown in FIG. 7(a) on a display user interface. When detecting a selection for Jack, the terminal hides other two contacts, as shown in FIG. 7(b). The terminal presents a preset group attribute of Jack; for example, if three preset group attributes are included: “colleagues”, “classmates”, and “relatives”, the terminal displays the three preset group attributes on the display user interface. If the terminal detects a second operation for the “colleagues”, as shown in FIG. 7(c), the terminal presents a contact that has the preset group attribute “colleagues” as a to-be-selected object on the display user interface. The terminal detects a curved slide operation, and a start point of the curved slide operation is Jack, and a track of the curved slide operation passes through five contacts. Therefore, the five contacts constitute one group, as shown in FIG. 7(d). In addition, an editing option includes “Send a message” and “Send an email”. If the terminal detects a triggering operation for the editing option “Send a message”, that is, when the track of the curved slide operation further passes through an induction area of the “Send a message”, the terminal presents an editing interface corresponding to the “Send a message” on the display user interface, as shown in FIG. 7(e).

Based on a same invention concept as that of the embodiment corresponding to FIG. 2, referring to FIG. 8, an embodiment of the present invention further provides an apparatus for creating a group, which is equivalent to the terminal in FIG. 2. In this embodiment, content covered in the embodiment corresponding to FIG. 2 is not described again.

Referring to FIG. 8, an embodiment of the present invention provides an apparatus for creating a group, including: a display unit 80 and a processing unit 81. The display unit 80 is corresponding to a display device in a terminal device. The processing unit 81 is corresponding to a processor in the terminal device.

The display unit 80 is configured to present at least one object on a display user interface.

The processing unit 81 is configured to: when a first operation for a first object is detected, reserve at least one to-be-selected object on the display user interface according to a preset group attribute of the first object, and trigger the at least one to-be-selected object to enter a to-be-grouped editing state, where the first object is any object in the at least one object, the first operation is used to trigger the first object to enter the to-be-grouped editing state, and the to-be-selected object and the first object have any same preset group attribute; and
when a curved slide operation is detected, and a track of the curved slide operation passes through multiple to-be-selected objects an odd number of times, use the multiple to-be-selected objects as one group, where the track of the curved slide operation is a non-closed curve.

In one embodiment, the processing unit 81 is configured to:
when the at least one to-be-selected object is reserved on the display user interface according to the preset group attribute of the first object; and when the first object has only one preset group attribute, use an object that has the only one preset group attribute as the to-be-selected object, and reserve the object on the display user interface.

In one embodiment, the processing unit 81 is configured to:
when the at least one to-be-selected object is reserved on the display user interface according to the preset group attribute of the first object, and when the first object has at least two preset group attributes, present the at least two preset group attributes on the display user interface; and
when a second operation for at least one preset group attribute in the at least two preset group attributes is detected, use an object that has the at least one preset group attribute as the to-be-selected object, and reserve the object on the display user interface, where the second operation is used to enable the apparatus to determine an object that needs to be reserved on the display user interface.

In one embodiment, the display unit 80 is configured to: when the at least one object is presented on the display user interface, present at least one preset group attribute of the first object on the display user interface.

The first operation is: determining a target preset group attribute, and triggering the first object to enter the to-be-grouped editing state, where the target group attribute is one of the at least one preset group attribute.

The processing unit 81 is configured to: when the at least one to-be-selected object is reserved on the display user interface according to the preset group attribute of the first object, reserve all objects that have the target group attribute on the display user interface.

In one embodiment, the track of the curved slide operation is a curve starting with the first object.

In one embodiment, the processing unit 81 is further configured to:
when it is detected that the track of the curved slide operation is a closed curve starting and ending with any to-be-selected object, end a process of creating a group.

In one embodiment, the processing unit 81 is further configured to:
when it is detected that the track of the curved slide operation reaches a second object an odd number of times, change a background color of an induction area of the second object from a first color to a second color, where
the second object is any one of the at least one to-be-selected object, the second color and the first color are different, the first color is used to indicate that the second object is not selected, and the second color is used to indicate that the second object is selected.

In one embodiment, the processing unit 81 is further configured to: after the terminal uses the multiple to-be-selected objects as one group, present at least two editing options on the display user interface by using the display unit, where the editing option is used by a user to perform a uniform operation on an object in the group; and
when a triggering operation for any editing option is detected, perform an operation corresponding to the any editing option on the object in the group.

The described apparatus embodiment is merely an example. The units described as separate parts may or may not be physically separate, and parts displayed as units may or may not be physical units, may be located in one position, or may be distributed on a plurality of network units. Some or all the modules may be selected according to actual needs to achieve the objectives of the solutions of the embodiments. In addition, in the accompanying drawings of the apparatus embodiments provided by the present invention, connection relationships between modules indicate that the modules have communication connections with each other, which may be implemented as one or more communications buses or signal cables. A person of ordinary skill in the art may understand and implement the embodiments of the present invention without creative efforts.

Referring to FIG. 1, an embodiment of the present invention provides a terminal device, including: a display device 140, a memory 180, and a processor 150. The memory 180 is configured to store a computer program, and the processor 150 is configured to read the computer program stored in the memory 180 and implement the method in the embodiment of FIG. 2.

In one embodiment, the terminal device further includes: a radio frequency circuit 110, configured to perform network communication with a wireless network device.

In conclusion, the terminal can recommend at least one to-be-selected object to the user according to the detected first operation for the first object and the preset group attribute of the first object; and when detecting the curved slide operation of the user, the terminal uses the multiple to-be-selected objects through which the track of the curved slide operation passes an odd number of times as one group. Therefore, the terminal can quickly and centrally process the multiple to-be-selected objects, the operation is convenient, and the operation efficiency is improved.

A person skilled in the art should understand that the embodiments of the present invention may be provided as a method, a system, or a computer program product. Therefore, the present invention may use a form of hardware only embodiments, software only embodiments, or embodiments with a combination of software and hardware. In addition, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Obviously, a person skilled in the art can make various modifications and variations to the embodiments of the present invention without departing from the spirit and scope of the embodiments of the present invention. The present invention is intended to cover these modifications and variations provided that they fall within the scope of protection defined by the following claims and their equivalent technologies.

What is claimed is:

1. A method for creating a group, comprising:
presenting, by a terminal, at least one object on a display user interface;
in response to the terminal detecting a first operation for a first object, reserving at least one to-be-selected object on the display user interface according to a preset group attribute of the first object, and triggering the at least one to-be-selected object to enter a to-be-grouped editing state, wherein the first object is any object in the at least one object, wherein the first operation is used to trigger the first object to enter the to-be-grouped editing state, and wherein the to-be-selected object and the first object have any same preset group attribute; and
in response to the terminal detecting a curved slide operation and that a track of the curved slide operation passes through multiple to-be-selected objects an odd number of times, using the multiple to-be-selected objects as one group, wherein the track of the curved slide operation is a non-closed curve.

2. The method according to claim 1, wherein the reserving, by the terminal, at least one to-be-selected object on the display user interface according to a preset group attribute of the first object comprises:
when the first object has only one preset group attribute, using, by the terminal, an object that has the only one preset group attribute as the to-be-selected object, and reserving the object on the display user interface.

3. The method according to claim 1, wherein the reserving, by the terminal, at least one to-be-selected object on the display user interface according to a preset group attribute of the first object comprises:
when the first object has at least two preset group attributes, presenting, by the terminal, the at least two preset group attributes on the display user interface; and
when the terminal detects a second operation for at least one preset group attribute in the at least two preset group attributes, using an object that has the at least one preset group attribute as the to-be-selected object, and reserving the object on the display user interface, wherein the second operation is used to enable the terminal to determine an object that needs to be reserved on the display user interface.

4. The method according to claim 1, wherein the presenting, by a terminal, at least one object on a display user interface comprises:
presenting, by the terminal, at least one preset group attribute of the first object on the display user interface;
wherein the first operation includes determining a target preset group attribute, and triggering the first object to enter the to-be-grouped editing state, wherein the target preset group attribute is one of the at least one preset group attribute; and
wherein the reserving, by the terminal, at least one to-be-selected object on the display user interface according to a preset group attribute of the first object includes reserving all objects that have the target preset group attribute on the display user interface.

5. The method according to claim 1, wherein the track of the curved slide operation is a curve starting with the first object.

6. The method according to claim 1, further comprising:
in response to the terminal detecting that the track of the curved slide operation is a closed curve starting and ending with any to-be-selected object, ending a process of creating a group.

7. The method according to claim 1, further comprising:
in response to the terminal detecting that the track of the curved slide operation reaches a second object an odd number of times, changing a background color of an induction area of the second object from a first color to a second color,
wherein the second object is any one of the at least one to-be-selected object, the second color and the first color are different,
wherein the first color is used to indicate that the second object is not selected, and
wherein the second color is used to indicate that the second object is selected.

8. The method according to claim 1, further comprising: after the using, by the terminal, the multiple to-be-selected objects as one group, performing the follow operations:
presenting, by the terminal, at least two editing options on the display user interface, wherein the editing option is used by a user to perform a uniform operation on an object in the group; and
in response to the terminal detecting a triggering operation for any editing option, performing an operation corresponding to the any editing option on the object in the group.

9. An apparatus for creating a group, comprising:
a display unit, configured to present at least one object on a display user interface;
a processing unit, configured to: when a first operation for a first object is detected, reserve at least one to-be-selected object on the display user interface according to a preset group attribute of the first object, and trigger the at least one to-be-selected object to enter a to-be-grouped editing state, wherein the first object is any object in the at least one object, wherein the first operation is used to trigger the first object to enter the to-be-grouped editing state, and wherein the to-be-selected object and the first object have any same preset group attribute; and
in response to detecting a curved slide operation and that a track of the curved slide operation passes through multiple to-be-selected objects an odd number of times, use the multiple to-be-selected objects as one group, wherein the track of the curved slide operation is a non-closed curve.

10. The apparatus according to claim 9, wherein the processing unit is configured to:
when the at least one to-be-selected object is reserved on the display user interface according to the preset group attribute of the first object, and when the first object has only one preset group attribute, use an object that has the only one preset group attribute as the to-be-selected object, and reserve the object on the display user interface.

11. The apparatus according to claim 9, wherein the processing unit is configured to:
when the at least one to-be-selected object is reserved on the display user interface according to the preset group attribute of the first object, and when the first object has at least two preset group attributes, present the at least two preset group attributes on the display user interface; and
when a second operation for at least one preset group attribute in the at least two preset group attributes is detected, use an object that has the at least one preset group attribute as the to-be-selected object, and reserve the object on the display user interface, wherein the second operation is used to enable the apparatus to determine an object that needs to be reserved on the display user interface.

12. The apparatus according to claim 9,
wherein the display unit is configured to: when the at least one object is presented on the display user interface, present at least one preset group attribute of the first object on the display user interface;
wherein the first operation includes: determining a target preset group attribute, and triggering the first object to enter the to-be-grouped editing state, wherein the target preset group attribute is one of the at least one preset group attribute; and
wherein the processing unit is configured to: when the at least one to-be-selected object is reserved on the display user interface according to the preset group attribute of the first object, reserve all objects that have the target preset group attribute on the display user interface.

13. The apparatus according to claim 9, wherein the track of the curved slide operation is a curve starting with the first object.

14. The apparatus according to claim 9, wherein the processing unit is further configured to:
when the track of the curved slide operation is a closed curve starting and ending with any to-be-selected object, end a process of creating a group.

15. The apparatus according to claim 9, wherein the processing unit is further configured to:
in response to the track of the curved slide operation reaching a second object an odd number of times, change a background color of an induction area of the second object from a first color to a second color,
wherein the second object is any one of the at least one to-be-selected object, wherein the second color and the first color are different, wherein the first color is used to indicate that the second object is not selected, and wherein the second color is used to indicate that the second object is selected.

16. The apparatus according to claim 9, wherein the processing unit is further configured to: after the processing unit uses the multiple to-be-selected objects as one group, present at least two editing options on the display user interface by using the display unit, wherein the editing option is used by a user to perform a uniform operation on an object in the group; and
in response to detecting a triggering operation for any editing option, perform an operation corresponding to the any editing option on the object in the group.

17. A terminal device, comprising: a display device, a memory, and a processor, wherein the memory is configured to store a computer program, and wherein the processor is configured to read the computer program stored in the memory and implement the method according to claim 1.

18. The terminal device according to claim 17, further comprising: a radio frequency circuit, configured to perform network communication with a wireless network device.

19. The terminal device according to claim 17, wherein the processor is configured to read the computer program stored in the memory and implement the method according to claim 2.

20. The terminal device according to claim 17, wherein the processor is configured to read the computer program stored in the memory and implement the method according to claim 3.
